(19) United States
(12) Patent Application Publication
(10) Pub. No.: US 2009/0254944 A1
(43) Pub. Date: Oct. 8, 2009

(54) ALERT MANAGEMENT APPARATUS AND A METHOD OF ALERT MANAGMENT THEREFOR

(75) Inventors: Craig C. Watson, Hampshire (GB); Myriam Ribiere, Nozay (FR); Patricia M. Charlton, London (GB); Angus E. Reid, Hampshire (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/721,400

(22) PCT Filed: Dec. 9, 2005
(86) PCT No.: PCT/US05/44555

§ 371 Date: Jun. 11, 2007

(30) Foreign Application Priority Data
Dec. 17, 2004 (GB) 0427635.8

(51) Int. Cl. H04N 5/445

(52) U.S. Cl. 725/58

(57) ABSTRACT

An alert management apparatus (100) comprises a presentation item data store (107) providing first description data associated with a plurality of presentation items, such as audio clips. The alert management apparatus (100) further comprises an alert data store (103) storing second description data associated with an alert, such as an alert for a content item. An association processor (109) is coupled to the presentation item data store (107) and the alert data store (103) and is arranged to select a presentation item of the plurality of presentation items for the alert in response to the first description data and the second description data. For example, a presentation item matching the genre, artist and or title of a content item of the alert may be selected. A presentation processor (111) then presents the selected presentation item to a user when the alert is activated. The invention may allow an automatic customisation of alert notifications.

### FIELD OF THE INVENTION

The invention relates to an alert management apparatus and a method of alert management therefor and in particular to an alert management system providing improved customisation of alert notifications.

### BACKGROUND OF THE INVENTION

In recent years, the use and popularity of electronic applications and services for managing every day activities has increased explosively. For example, applications for assisting users in selecting TV programmes, managing appointments or communicating with other users have become prevalent. Many of these applications and services utilise alerts whereby a user may be alerted to an event, information or other relevant issues being of interest to the user.

Alerts may be set up by the user, for example by adding an appointment to a calendar program or selecting a TV programme from a TV schedule, or may be generated automatically, for example by an automatic selection of all TV programmes in a series. A static alert may for example be generated by a user manually entering text describing the characteristics and conditions of the alert, and when the conditions are met, the user will be alerted by whatever means available (e.g. a vibration alert or an alarm tone). Typically each application and service has its own method for the user to set up an application based alert.

An example of a current application using alerts is a television service known as MyDTV Content IQ™ which allows viewers to set up a personal profile for programming preferences for a number of defined categories. The system generates detailed metadata comprising characteristics of the transmitted TV programmes and continuously transmits the metadata to the viewers' set-top boxes. The set-top boxes monitor the metadata for upcoming programmes and if a programme is identified which matches the viewer-defined profile, a recommendation alert pops up on the channel the viewer is currently watching.

In the future it is expected that applications and services using alerts will become more numerous and it is likely that an individual user may be associated with a number of different applications and services and may therefore receive alerts from a plurality of sources. It is furthermore expected that applications and services will increasingly be used in dynamic and unpredictable environments. For example, it is expected that an increasing number of applications will run on mobile devices which may be carried by a user. Also applications and services may increasingly be used to provide alerts relating to changing conditions. For example, a traffic monitoring system may provide alerts indicating upcoming traffic jams in response to received dynamic traffic information. Hence, applications and services must increasingly adapt to dynamic environments.

However, in an environment wherein an increasing number of different alerts may be presented to a user or users, the requirement for the user to actively process, consider and evaluate an alert before deciding on a course of action increases. Thus the practicality, convenience and user friendliness may degrade as the number of possible alerts increases. Thus, a system allowing an improved user friendliness and facilitated or improved user interface is highly desirable.

Typical applications which allow for an alert to be generated only allow for the same alert tone or message type to be generated for all alerts. For example, for a calendar application, it is generally only possible to associate a single tone with an event reminder. Accordingly, the user must actively determine which event is associated with an alert. This is impractical in many situations and is inconvenient to the user.

In some areas, it is known to manually customise some alerts such that different alerts use different signals when alerting the user. In particular, in the field of mobile phones, it is known for the user to manually assign different ring tones to different identities in the mobile phone's phonebook thereby allowing different callers to be associated with different ring tones. In this way, the ring tone of an incoming call may not only alert the user to an incoming call but may also identify the caller.

However, although this approach may provide some benefits, it is an impractical approach for customisation of more than a few alerts. In particular, the manual customisation is slow and inconvenient for the user and will typically result in only a few identities being associated with specific ring tones. As the number of alerts become increasingly numerous and varied, the effort required by a user becomes prohibitive.

Furthermore, the approach requires that both the ring tone and the caller identity is known to the user and can be specified in advance. Hence, the approach is inflexible and static and is unsuitable for a dynamic environment where the nature and type of alerts may vary. For example, in many future applications, alerts may be automatically generated in response to characteristics which are not predefined. For example, alerts may be automatically generated in response to a gradually built up user profile. Thus, many alerts may not be actively setup by a user, and it may even be unknown to a user that an alert has been defined. Furthermore, the alerts may be unpredictable, and it is thus not possible to manually assign alert signals to the alerts.

Hence, an improved alert management system would be advantageous and in particular an alert management system allowing for increased flexibility, improved customisation, increased user friendliness, improved user interface, increased suitability for dynamic and/or unpredictable alert environments and/or improved alert performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention, there is provided an alert management apparatus comprising: means for providing first description data associated with a plurality of presentation items; means for providing second description data associated with an alert; means for selecting a selected presentation item of the plurality of presentation items for the alert in response to the first description data and the second description data; and means for presenting the selected presentation item to a user when the alert is activated.

The invention may allow a suitable presentation item for an alert to be automatically selected and presented to the user upon activation of the alert. The invention may allow selection of a suitable presentation item by exploiting information of description data of both the alert and presentation items. The description data may for example be metadata or text data associated with an alert or presentation item. For example, the second description data may comprise titles or file names of each of the plurality of presentation items.

The invention may provide for a flexible association of alerts with presentation items allowing for a flexible and/or dynamic selection of a suitable presentation item for a given alert. By exploiting available description data, the selection may, in some embodiments, be performed without any user involvement or interaction. The approach is suitable for unpredictable environments wherein dynamic and automatic alerts may be defined. For example, a large number of suitable presentation items, such as alert melodies, may be stored and when an alert is defined, the most suitable stored presentation item may be automatically selected.

The invention may allow an improved user interface and may specifically allow an improved differentiation between alert notifications. The invention may provide a presentation of an alert, for example by automatically selecting different alert melodies for different types of alerts, that provide additional information to the user without further consideration or investigation by the user being necessary. A more convenient alert notification to the user may be provided requiring less active involvement by the user in determining characteristics of the alert.

The selection of the presentation item may be performed at any suitable time, such as when an alert is defined or when an alert is activated. The means for selecting may, for example, be operable to select the selected presentation item by evaluating a match criterion for the first and the second description data associated with each of the plurality of presentation items. The selected presentation item may be selected as the presentation item which provides the best match in accordance with the match criterion.

In some embodiments, the invention may particularly allow for a customisation of presentation items to characteristics of the alert without requiring the user to manually assign alert notification signal to alerts.

According to an optional feature of the invention, the alert is a content item alert. The alert may be defined for a content item, such as e.g. a film, a TV program, a song, a news item, an electronic article etc. The invention may allow for a customisation of alert presentations to the content item. For example, different melodies may be used as alerts for different genres of TV programmes.

According to an optional feature of the invention, the second description data comprises content description data associated with the content item. This may allow a practical and low complexity implementation. Alternatively or additionally, the feature may e.g. allow improved performance, for example by providing for a more suitable presentation item to be selected for a given alert.

According to an optional feature of the invention, the means for selecting is operable to select the selected presentation item in response to a semantic meaning of the second description data. This may provide for improved selection of suitable presentation items. For example, rather than comparing the first and second description data directly, a semantic meaning of the description data may be determined in accordance with any suitable algorithm and the selected presentation item may be chosen in response to the semantic meaning. This may allow increased flexibility as suitable alerts and presentation items may be associated despite having different data formats or structures.

According to an optional feature of the invention, the means for selecting is operable to select the selected presentation item in response to a match between data of a field of the second description data and data of a field of the first description data associated with the selected presentation item.

The data fields may for example comprise data related to specific corresponding description data. This may allow a suitable and low complexity selection of the selected presentation item.

According to an optional feature of the invention, the means for selecting is operable to select the selected presentation item in response to a match between a categorisation of the alert and a categorisation of the selected presentation item. The categorisation may for example be a categorisation of the data into different predetermined categories such as a theme, genre, artist, title etc. This may allow a suitable and low complexity selection of the selected presentation item. For example, if an alert is set for an event involving a specific singer, a song by that singer may automatically be selected as the presentation item used when alerting the user of the alert being activated.

According to an optional feature of the invention, the means for selecting is operable to select the selected presentation item in response to a user profile. This may provide for improved determination of a suitable presentation item and may in particular allow improved customisation of the alert presentation to not only the characteristics of the alert but also to the specific characteristics of the user. The user profile may for example be a user preference profile.

According to an optional feature of the invention, the means for selecting is operable to select the selected presentation item in response to the user profile comprising a shared preference for the selected presentation item and an item associated with the alert. This allows for improved and low complexity selection of a suitable presentation item.

According to an optional feature of the invention, the alert management apparatus further comprises means for determining concept data by concept extraction from text based second description data and the means for selecting is operable to determine the selected presentation item in response to the concept data.

This may provide for a suitable implementation and may allow for automatic customisation of alert presentations based on general text data. The text data may be general text data which is not dedicated to the selection of a presentation item. For example, the text may be descriptive text for the alert (such as a meeting description in a calendar application). The feature may allow existing text based user inputs or other text data to be used to select the presentation item and may thus allow the invention to be employed in many text based applications.

According to an optional feature of the invention, the means for selecting is operable to select the selected presentation item in response to a user context.

This may provide for improved determination of a suitable presentation item and may in particular allow improved customisation of the alert presentation to not only the characteristics of the alert but also to the specific characteristics of the user context.

According to an optional feature of the invention, the means for selecting comprises: means for identifying a subset of presentation items of the plurality of presentation items in response to the first description data and the second description data; means for presenting an indication of the subset of presentation items to a user; and means for selecting the selected presentation item from the subset of presentation items in response to a user input.

This may allow an improved user interface and may allow a user to exercise control over the selection of the presentation item without requiring that the user manually and actively identify suitable items.

According to an optional feature of the invention, the first description data and the second description data comply with a same ontology. This may facilitate selection of the selected presentation item and may allow for an improved selection of a suitable presentation item.

According to an optional feature of the invention, the first description data complies with a first ontology and the second description data complies with a second ontology; and the alert management apparatus further comprises means for translating between the first and the second ontology.

The translation may be from the first ontology to the second ontology, from the second ontology to the first ontology and/or from the first and second ontology to a shared third data structure allowing comparison. The translation may for example be of specific data or by selection of data of specific ontology elements. For example, the translation may be by selecting a specific data element of the first ontology (e.g. an artist identification) and selecting the corresponding data element from the second description data in accordance with the second ontology.

This may provide for a low complexity implementation in embodiments where different ontologies are used for the first and second description data.

According to an optional feature of the invention, the alert management apparatus further comprises a data store comprising the first description data and the plurality of presentation items. The presentation item may be selected from a local store of possible presentation items. This may allow for a low complexity implementation.

According to an optional feature of the invention, the means for providing the first description data is operable to receive the first description data from a remote server and the apparatus further comprises means for accessing the remote server to receive the selected presentation item. This may allow improved performance and may for example allow selection of suitable presentation items from a large central server comprising a large number of possible presentation items.

According to an optional feature of the invention, the alert management apparatus further comprises means for generating a presentation item in response to a content item associated with the alert.

For example, the means for selecting may be operable to determine that an existing plurality of content items does not comprise a suitable presentation item and in this case may generate a presentation item in response to the content item and include this in the plurality of presentation items. The new presentation item may then be selected as the selected presentation item. This may improve the association of suitable presentation items for alerts.

According to an optional feature of the invention, the means for generating the presentation item is operable to generate the presentation item by extracting a content sub-item from the content item.

The presentation item may for example be generated by extracting a content sub-item from the content item and using this as the presentation item. The content sub-item may for example be a picture from a video content item, a short video clip from a longer video content item or an audio clip from a song content item. The means for generating may specifically be operable to generate the presentation item in response to a user input. For example, the user may select a start and an end of a video or audio clip from an audio visual content item.

The feature may provide for a practical, low complexity and user friendly way of generating suitable presentation items.

According to an optional feature of the invention, the presentation item is an audiovisual item. The presentation item may for example be an audio only item, such as a theme tune or a song, may be video only, such as a still picture or a moving image sequence, or may be a combination of audio and video.

According to a second aspect of the invention, there is provided a method of alert management apparatus comprising: providing first description data associated with a plurality of presentation items; providing second description data associated with an alert; selecting a selected presentation item of the plurality of presentation items for the alert in response to the first description data and the second description data; and presenting the selected presentation item to a user when the alert is activated.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an alert management apparatus in accordance with some embodiments of the invention.

### DETAILED DESCRIPTION OF EMBODIMENTS OF THE INVENTION

In the future, an increasing number of applications and services will use user alerts as an integral part of the interface to users. Alerts may for example be simple meeting reminders or general alerts e.g. related to complex actions, events or content items. For example, alerts may be specifically set up by a user, may be generated automatically and/or may be received from external sources. In particular, many applications and alerts may be focussed on group or community based services and alerts may be set-up by or in response to actions by other users. Also, alerts will increasingly be used in dynamic environments such as in portable devices including e.g. Personal Digital Assistants (PDAs) or mobile phones.

The following description focuses on embodiments of the invention applicable to an alert system for content related alerts that assist users in getting access to appropriate content items, such as TV programmes. However, it will be appreciated that the invention is not limited to this application but may be applied to many other alerts including for example alerts for specific events, activities or alerts indicative of certain conditions occurring (such as a user group being formed or another member joining a group).

The following description furthermore focuses on embodiments wherein the alerts have been set-up or defined in an alert management system. Typically, the alerts have been manually or automatically setup.

A manual alert definition is in the example explicitly set by the user. The user may for example specify an alert to remind them of a task or an action. As another example, a user may specify a content item alert by selecting a specific content item, such as a specific TV programme or a specific song. For the alert to be triggered, a known set of conditions associated with the alert must occur. These conditions may be set explicitly by the user or may be inferred from the alert definition and other available information. The conditions may relate to the item for which the alert is set or may relate to other issues such as the user or a user application. For example, a dynamic alert may be triggered when the user context meets a given criterion.

An automated alert definition is generally not specifically set by the user but becomes active when some set of conditions or preferences become true. For example, a user preference may be determined and alerts may be defined for content items specifically matching the user's preferences. This alert definition may occur without the user's involvement.

As specific examples, an alert may be defined by:
the user specifically selecting a particular content or service and a particular time.
the user specifying a particular content or service without any timing specification.
the user specifying a particular type of content or service.
the user specifying a set of criteria for a content item (genre, keywords, etc.).
the user selecting a specific event.
the system performing a learning process on the user behaviour and automatically selecting items suitable for the user.

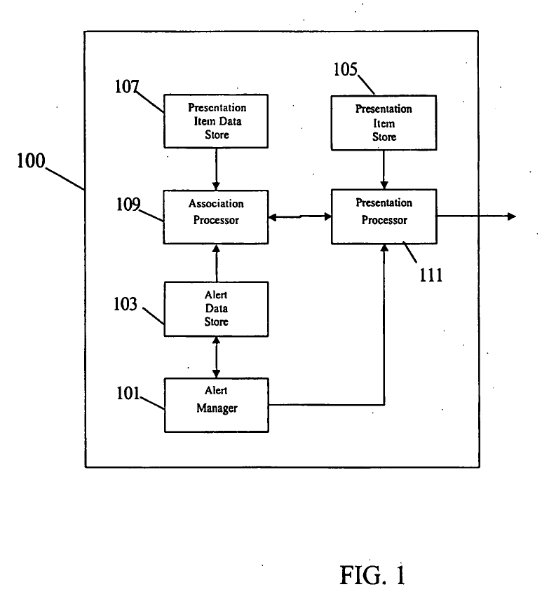

FIG. 1 illustrates an alert management apparatus 100 in accordance with an embodiment of the invention.

The alert management apparatus 100 comprises an alert manager 101 which is operable to setup/define alerts either dynamically or manually by interfacing with a user of the alert management apparatus 100.

The alert manager 101 is coupled to an alert data store 103 which may be a suitable memory medium such as RAM (Random Access Memory), PROM (Programmable Read Only Memory) or a magnetic or optical storage medium such as a hard disk. When the alert manager 101 sets up a new alert, it stores data associated with the alert in the alert data store 103. The data stored includes alert information such as information of when the alert becomes active and should be presented to the user.

However, in accordance with the example of FIG. 1, the alert manager 101 furthermore stores alert description data which is associated with the alert in the alert data store 103. In particular, when the alert is for a content item such as an upcoming TV programme, the alert manager 101 stores content description data. Thus, in addition to a time when the alert becomes active, the alert manager 101 may furthermore store information related to a type or genre of the TV programme, a start time and end time of the TV programme, artists and actors appearing in the TV programme etc.

In particular, for an alert management apparatus 100 for a content distribution system, metadata may be distributed and stored with the alert. For example, a TV network may include transmission of an Electronic Programme Guide (EPG) comprising a description of upcoming programmes. The alert manager 101 may automatically or in response to user inputs set up an alert for a specific upcoming programme. Hence, the alert manager 101 may store alert data indicating that an alert should be activated, say, ten minutes before the start of the programme. In addition, the alert manager 101 may store all data of the EPG for the programme. In the example, the stored description data thus comprises a description of the programme.

The alert management apparatus 100 furthermore comprises a presentation item store 105 which comprises a plurality of different presentation items that may be used by the alert management apparatus 100 when presenting the alerts. In the specific example, audio only alerts may be generated and the presentation item store 105 comprises a number of different encoded audio clips such as a relatively large number of MP3 music clips. The music clips may for example be relatively short clips of around 5-10 seconds from various songs and theme tunes.

In addition, the alert management apparatus 100 comprises a presentation item data store 107 which comprises presentation description data that is associated with the plurality of presentation items stored in the presentation item store 105. The alert description data comprises information describing the presentation items and may specifically comprise content description data. In the specific example, the presentation description data may for example comprise information indicating a genre, artist and title of each music clip stored in the presentation item store 105. The presentation description data may also comprise information of e.g. an activity associated with the individual music clips. For example, the presentation description data may indicate that a music clip for a theme tune of a football programme is associated with football.

The alert management apparatus 100 also comprises an association processor 109 which is coupled to the alert data store 103 and the presentation item data store 107. The association processor 109 is operable to select a presentation item of the plurality of presentation items stored in the presentation item store 105 for an alert. Thus, the association processor 109 may select a suitable presentation item in response to the alert description data and the presentation description data, and in particular the association processor 109 may for a given alert retrieve the associated description data from the alert data store 103 and search through the description data of the presentation item data store 107 in order to find a presentation item with matching content data.

As a specific example, an alert may be set for a TV programme. In response, the association processor 109 may identify a genre of the TV programme. This may for example be one of a predefined group such as [Sports, game show, film, news, other]. The association processor 109 may subsequently search the data of the presentation item data store 107 to see if any presentation items match the genre of the current programme.

If a single match is found, the association processor 109 may associate the alert with this presentation item. For example, if the presentation item store 105 comprises only one music clip associated with news (e.g. a theme tune for a well known news programme), an alert for a news programme may be associated with this music clip. If more than one match is found—or if no matches are found—the association processor 109 may proceed to evaluate a second characteristic. For example, it may determine an artist associated with the programme and determine if any of the presentation items comprise description data identifying the same artist. As a specific example, a film featuring—or being about—a pop star may be associated with a music clip of a song by that pop star.

The alert management apparatus 100 further comprises a presentation processor 111 which is coupled to the association processor 109, the presentation item store 105 and the alert manager 101. When an alert becomes active, this is detected by the alert manager 101 which feeds this information to the presentation processor 111. In response, the presentation processor 111 accesses the association processor 109 in order to determine which presentation item is associated with the alert. The presentation processor 111 then accesses the presentation item store 105 using this information and retrieves the associated presentation item and presents it to the user (if no specific presentation item is associated with the alert, a default presentation item may be used). Thus, the alert management apparatus 100 of FIG. 1 may allow for an automatic association of alerts and presentation items. Hence, an improved user interface may be provided where the user may be provided with alert notifications that immediately provide enhanced information of the cause of the alert. The improved customisation of alert notifications to different alerts may be achieved with reduced or no user involvement. Furthermore, the alert management system may automatically associate presentation items in response to description data, which in many embodiments is provided for other purposes (such as EPG data). In particular, the system may allow for metadata of content items to be used to select a suitable alert notification providing additional information.

For example, in a TV distribution network, a recommender function may automatically generate alerts for the user based on the user's previous preferences and without requiring specific input from the user. The alert management system may further allow the alert notifications to be automatically customised to the content of the alert by selecting a matching music clip from a local library of music clips. Thus, an alert notification for a football programme may be executed by playing a short theme tune from a well known sports programme, a science fiction film by playing a tune associated with a science fiction film (say the initial bars of the “star Wars” tune), a music programme by a clip of the current chart topper etc.

As a specific example, a user may manually set an alert for an upcoming football program. The alert manager 101 has access to metadata (e.g. the “Title”, “Synopsis” and “Genre” of the program (i.e. Sport\Football)) and this knowledge about the program allows the alert manager 101 to attempt to customise the alert notification to the content itself. Specifically, for an audio alert, an alert signal may be selected to correspond to the actual theme tune of the given program or to a generic alert tune that is associated with football in the popular conscious. Accordingly, when the alert is activated, the user will immediately understand what type of content they have been alerted to. Similarly, should the user have their device set to non-audio alert, the system may select an image associated with the given program.

As another example, the user may be able to set up criteria for special alerts that will be automatically stored in a personalisation module. These may indicate content that the user desires to be alerted about. E.g. entering the keyword “Pop diva” may result in any incoming content with metadata including the keyword “Pop diva” activating an alert. Further, a program having the exemplary synopsis metadata “Pop diva Britney Spears discusses her new album” may be evaluated by the alert manager 101 which may associate the artist Britney Spears' signature tune “Baby one more time” with this alert. Upon hearing this alert notification, the user would immediately understand the nature of the content without requiring any further action on behalf of the user.

FIG. 1 illustrates functional blocks of the apparatus of some embodiments of the invention. The individual functional blocks may for example be implemented in a suitable processor such as a microprocessor, a microcontroller or a digital signal processor. The functions of the illustrated blocks may for example be implemented as firmware or software routines running on suitable processors or processing platforms. However, some or all of the functional blocks may be implemented fully or partially in hardware. For example, the functional blocks may be fully or partially implemented as analogue or digital circuitry or logic.

The functional blocks may furthermore be implemented separately or may be combined in any suitable way. For example, the same processor or processing platform may perform the functionality of more than one of the functional blocks. In particular, a firmware or software program of one processor may implement the functionality of two or more of the illustrated functional blocks. For example, the alert manager 101 and the association processor 109 may be implemented as different firmware routines running in a single processor. The functionality of different functional modules may for example be implemented as different sections of a single firmware or software program, as different routines (e.g. subroutines) of a firmware or software program or as different firmware or software programs.

The functionality of the different functional modules may be performed sequentially or may be performed fully or partially in parallel. For example, a single firmware program may perform the operation of the alert manager 101 followed by the operation of the association processor 109. As another example, one processor may perform the operation of the alert manager 101 and the presentation processor 111 whereas another processor (or another processing element) may perform the functionality of the association processor 109. Parallel operation may include a partial or full time overlap between the performed functions.

The data stores are typically implemented by memory including dynamic or static or semi-permanent semiconductor memory. For example, the presentation item store 105, presentation item store 105 and/or alert data store 103 may be implemented by integrated or separate Random Access Memory (RAM) or (Programmable) Read Only Memory (ROM). The data stores may also fully or partially be implemented by other memory types including magnetic and/or optical memories including hard disk or optical disc based memories.

It will be appreciated that the data store for storing the presentation items and the alert description data may be distributed between different modules as in the example of FIG. 1 or may be integrated into a single module. Furthermore, the storage of the presentation description data may be separate from or integrated with the storage of the alert description data and/or the presentation items and/or the alert activation information.

In some embodiments the association processor 109 selects the presentation item in response to a semantic meaning of the presentation description data. Thus, the system may provide an automated or semi automated knowledge-based approach to associating semantically meaningful alert themes to alerts in order to enhance the user's recognition of alerts and reduce the manual effort/time required for them to achieve this.

The association processor 109 may associate any metadata or natural language data describing an event alert with the alert and then use reasoning tools to derive a semantic understanding of the nature of the alert. With this semantic understanding, the association processor 109 may employ matching tools to identify appropriate presentation items and associate them with the alert.

It will be appreciated that any known method for determining/estimating a semantic meaning indication may be used without detracting from the invention. For content genres, metadata can for example be used to establish the main theme or genre of the content and this may be refined through examining other content indicators in the content title/synopsis and associated participants in the program.

For example a set of concepts that define date and time, an event, a transaction, a genre, a TV title, and a location may be known as an ontology. In such an example, connections between ontologies may be detected, such as when the date and time on a photograph is the same concept as the time on a weather report, and rules may be designed to take advantage of such connections. This enables the creation of a rule, an inference, based on the semantics captured through the ontology and the language used. This may allow an alert system to automatically identify matching presentation items using semantic analysis. For example, photos taken on sunny days (visual alert) or music theme tune (audio alert) about sunny days may be used.

Semantic data models have emerged from a requirement for more expressive conceptual data models. Many current data models lack direct support for relationships, data abstraction, inheritance, constraints, unstructured objects, and the dynamic properties of an application. A formal semantic model, such as that proposed by an ontology language, enables capturing of the properties of relationships explicitly so that a computational system can automatically reason to infer in any particular context whether or not the relationship holds true.

When data is captured on the principles of explicit formal semantics this inferencing can be done across applications.

In contrast to semantic data, non-semantic data generally refers to data models that are not designed to formally and explicitly represent semantics about their data. Typically, non-semantic data represents the structure and integrity of the data elements of the specific enterprise application(s) by which it will be used. Therefore, the conceptualisation and the vocabulary of such a data model are not intended to be shared by other applications.

In some embodiments, the content items and the presentation items may be categorised into different categories. For example, the alert manager 101 may comprise a fixed number of different categories and when a content item alert is set, the alert manager 101 may proceed to determine which of the predetermined categories the content item belongs to. Furthermore, the presentation items may be associated with one of the categories and the alert manager 101 may proceed to select a presentation item for the content item alert as a presentation item which is associated with the same category.

In some embodiments, the alert manager 101 may select a presentation item if data of a specific field of the presentation description data matches data of a specific field of the alert description data. For example, the metadata associated with the content items for which alerts are set may comprise a field indicating an associated artist. Similarly, the data of the presentation items may comprise a field for each presentation item identifying an artist associated with the presentation item. If the artist data of the content item matches that of a presentation item, this presentation item may be selected.

In some embodiments, the alert description data and the presentation description data may each be structured in accordance with an ontology. An ontology is a shared understanding of some domain of interest. In particular, an ontology provides a reference frame and definition for various concepts used in a particular domain. A concept can be a physical (concrete) object of the domain (a book in the domain of book sellers) or an abstract object (the selling book process in the domain of book sellers). A number of different properties (parameters and characteristics) of a given concept may be represented in an ontology. Thus, for a defined ontology which is shared between applications, the different applications may exchange information relating to characteristics of objects (concrete or abstract) by using the defined ontology. This allows applications to accurately and effectively exchange information without requiring the objects to be predefined at the time of the design of the applications. Thus ontologies are used for sharing a consistent understanding of what information means and also allows knowledge re-use as a common reference for different applications.

In some embodiments, the alert and presentation description data may be using the same ontology. For example, if an ontology is used for metadata of the received content items, the alert description data may be organised and stored in the presentation item data store 107 using the same ontology. This may allow for a facilitated operation of the alert manager 101 and may in particular be suitable for determining if specific data, such as an artist name, matches between the alert and the presentation item. In particular, the alert manager 101 may easily identify the given specific data by accessing the same data field of the alert and presentation description data using the data structure information of the ontology.

In some embodiments, the alert and presentation description data are organised in accordance with different ontologies. For example, the content item may be a TV programme for which metadata is structured in accordance with a TV programme ontology whereas the presentation items are MP3 audio clips for which metadata is structured in accordance with a song ontology.

In some such embodiments, the alert management apparatus 100 may comprise functionality for inferring between related properties of the different ontologies.

Alternatively or additionally, the alert management apparatus 100 may comprise functionality for translating between the different ontologies. The translation may be explicit and complete wherein data according to one ontology is completely restructured to comply with the other ontology. However, in other embodiments, the translation may be partial—either by only some data being translated and/or by the translation being to a third data structure allowing for the data of the different ontologies being compared.

In a simple embodiment, the translation may simply comprise selecting a first data field, such as a field identifying an artist, in accordance with the data structure of one of the ontologies and then selecting a corresponding data field of the data structured in accordance with the second ontology. The specific data fields may be compared and the presentation item may be selected if the data match.

In some embodiments, the alert management apparatus 100 further comprises means for determining a user profile. For example, the apparatus 100 may comprise a recommender/learning system which monitors the users behaviour and automatically determines a users preference for different content items. For example, if the user frequently watches sports programmes, the user profile may indicate a high preference for these programmes. The recommender may set alerts for upcoming programmes in response to this preference.

The association processor 109 may in some embodiments be arranged to select a presentation item in response to a user profile. For example, if the user profile indicates a higher preference for a first sports programme than for a second sports programme, the alert manager 101 may select the theme tune of the first sports programme rather than the theme tune of the second sports programme for an alert for a third sports programme.

The alert manager 101 may as an example select a presentation item if the user profile indicates a shared preference for the content item and the presentation item. For example, the user preference indicator may indicate a high preference for music programmes featuring a specific artist and the alert manager 101 may accordingly select an audio clip with that artist as a presentation item for all music programmes.

In some embodiments, the alert management apparatus 100 may comprise functionality for determining concept data by concept extraction from text based data, and the alert manager 101 may determine the selected presentation item in response to this concept data.

For example, the metadata for content data may comprise text based information to be presented in an EPG. This text may be evaluated by natural language processing to determine an associated concept and this analysis may be used to select the presentation item. It will be appreciated that different techniques for extracting concept information from text will be known to the person skilled in the art and will for brevity not be described further herein.

In some embodiments, the alert manager 101 is arranged to select a presentation item in response to a user context.

The user context may relate to the physical context of the user such as whether the user is static or mobile, the location of the user, a current time of day or the environment in which the user currently is. The user context may also relate to e.g. an application context such as characteristics of the applications which are currently being executed by the user. In some embodiments, the user context may relate to an activity currently being performed by the user.

Context may specifically be considered any information that can be used to characterize the situation of a user when referring to user context. However, more generally a user context may be considered as characterising the situation of an entity, where an entity can be a person, place or object that is considered relevant to the interaction between a user and an application, including the user and the application themselves. Context includes, e.g., location, lighting, noise level, physical activity, time of day, network connectivity, communication costs, communication bandwidth, need for privacy, social situation, history information, and user profile and user-defined interests.

The alert manager 101 may determine data associated with the user context and may vary the presentation item accordingly. For example, if the user is currently in a vehicle, an audio only presentation item may be selected whereas if the user is in a home environment a full audiovisual presentation item may be used.

In some embodiments, the alert manager 101 may not select a single presentation item but may select a subset of presentation items which are considered appropriate. These items may be presented to the user who may select one of the presentation items to be used for the alert. Thus a semi-automatic approach may be used where the user retains control of which alert notification is used but with a much facilitated operation as the most appropriate items are automatically identified and the user merely needs to make a selection between these.

In some embodiments, the alert management apparatus 100 may comprise functionality for generating a presentation item. In particular, if no suitable presentation item is identified, a presentation item may be generated from a content item associated with the alert. The presentation item may be generated by extracting some of the content from the content item to generate a content sub-item. For example, a presentation item may be generated by selecting a short audio or video clip from the content item.

As a specific example, if the user has just watched a program about “Mohammed Ali” but initially there was no available presentation item to associate with the alert, then at the end of the program the user may be encouraged to generate a presentation item from the program (it is assuming that this is stored in a suitable format, such as an MPEG-2 signal stored on a hard disk). The user may then rewind through the program and capture an image still that can be stored for future alerts. Alternatively or additionally, they may capture a segment of audio and store it in the presentation item store 105 in a suitable format (e.g. mp3 or .wav) to be associated with future alerts for content that includes “Mohammed Ali”.

The above description has focussed on an embodiment wherein the presentation items and the presentation description data was stored locally at the alert management apparatus 100. However, in some embodiments, the alert management apparatus 100 alternatively or additionally comprises functionality for receiving description data from a remote server and for accessing the remote server to retrieve a selected presentation item.

For example, the alert management apparatus 100 may comprise a network interface that allows it to communicate with remote servers over a network. In particular, the alert management apparatus 100 may comprise an Internet interface that allows it to connect to external servers for downloading data of available presentation items, such as ring tones, as well as the presentation items themselves. This may provide a high degree of customisation as a large number of presentation items may be accessed from external sources.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. An alert management apparatus comprising:
means for providing first description data associated with a plurality of presentation items;
means for providing second description data associated with an alert;
means for selecting a selected presentation item of the plurality of presentation items for the alert in response to the first description data and the second description data; and
means for presenting the selected presentation item to a user when the alert is activated.

2. The alert management apparatus of claim 1 wherein the alert is a content item alert.

3. The alert management apparatus claimed in claim 2 wherein the second description data comprises content description data associated with the content item.

4. The alert management apparatus of claim 1 wherein the means for selecting is operable to select the selected presentation item in response to a semantic meaning of the second description data.

5. The alert management apparatus of claim 1 wherein the means for selecting is operable to select the selected presentation item in response to a match between data of a field of the second description data and data of a field of the first description data associated with the selected presentation item.

6. The alert management apparatus of claim 1 wherein the means for selecting is operable to select the selected presentation item in response to a match between a categorisation of the alert and a categorisation of the selected presentation item.

7. The alert management apparatus of claim 1 wherein the means for selecting is operable to select the selected presentation item in response to a user profile.

8. The alert management apparatus claimed in claim 7 wherein the means for selecting is operable to select the selected presentation item in response to the user profile comprising a shared preference of the selected presentation item and an item associated with the alert.

9. The alert management apparatus of claim 1 further comprising means for determining concept data by concept extraction from text based second description data and wherein the means for selecting is operable to determine the selected presentation item in response to the concept data.

10. The alert management apparatus of claim 1 wherein the means for selecting is operable to select the selected presentation item in response to a user context.

11. The alert management apparatus of claim 1 wherein the means for selecting comprises:
means for identifying a subset of presentation items of the plurality of presentation items in response to the first description data and the second description data;
means for presenting an indication of the subset of presentation items to a user; and
means for selecting the selected presentation item from the subset of presentation items in response to a user input.

12. The alert management apparatus of claim 1 wherein the first description data and the second description data comply with a same ontology.

13. The alert management apparatus of claim 1 wherein the first description data complies with a first ontology and the second description data complies with a second ontology; and the alert management apparatus further comprises means for translating between the first and the second ontology.

14. The alert management apparatus of claim 1 further comprising a data store comprising the first description data and the plurality of presentation items.

15. The alert management apparatus of claim 1 wherein the means for providing the first description data is operable to receive the first description data from a remote server and the apparatus further comprises means for accessing the remote server to receive the selected presentation item.

16. The alert management apparatus as of claim 1 further comprising means for generating a presentation item in response to a content item associated with the alert.

17. The alert management apparatus claimed in claim 16 wherein the means for generating the presentation item is operable to generate the presentation item by extracting a content sub-item from the content item.

18. The alert management apparatus of claim 1 wherein the presentation item is an audiovisual item.

19. A method of alert management comprising:
providing first description data associated with a plurality of presentation items;
providing second description data associated with an alert;
selecting a selected presentation item of the plurality of presentation items for the alert in response to the first description data and the second description data; and
presenting the selected presentation item to a user when the alert is activated.

20. (canceled)
